(19) United States
(12) Patent Application Publication
(10) Pub. No.: US 2012/0036394 A1
(43) Pub. Date: Feb. 9, 2012

(54) DATA RECOVERY METHOD, DATA NODE, AND DISTRIBUTED FILE SYSTEM

(75) Inventor: Huan FENG, Chengdu (CN)

(73) Assignee: CHENGDU HUAWEI SYMANTEC TECHNOLOGIES CO., LTD., Chengdu (CN)

(21) Appl. No.: 13/273,992

(22) Filed: Oct. 14, 2011

Related U.S. Application Data
(63) Continuation of application No. PCT/CN2010/071267, filed on Mar. 24, 2010.

(30) Foreign Application Priority Data
Apr. 15, 2009 (CN) 200910134941.3

(51) Int. Cl. G06F 11/20

(52) U.S. Cl. 714/4.12; 714/E11.09

(57) ABSTRACT

A data recovery method includes: by a first data node, obtaining a notification that a second data node fails; and storing specified data to a third data node, recording information of the specified data stored in the third data node in backup information stored in the first data node, and providing a metadata node and other data nodes storing the specified data with the information of the specified data stored in the third data node, where the specified data is data stored in the first and second data nodes. A data recovery method, two data nodes, and a distributed file system are also provided. In embodiments of the present invention, the data recovery is mainly performed among the data nodes, and the metadata node does not need to perform a lot of operations. Therefore, the load of the metadata node is reduced.

### CROSS-REFERENCE TO RELATED APPLICATIONS

This application is a continuation of International Application No. PCT/CN2010/071267, filed on Mar. 24, 2010, which claims priority to Chinese Patent Application No. 200910134941.3, filed on Apr. 15, 2009, both of which are hereby incorporated by reference in their entireties.

### FIELD OF THE INVENTION

The present invention relates to a distributed file system, and in particular, to a data recovery technology in the distributed file system.

### BACKGROUND OF THE INVENTION

The risk of failure exists in all single disks and complex storage devices. Therefore, in a distributed file system, the same data is normally stored at the same time in multiple data nodes which are the devices for storing data in the distributed file system. As a result, the whole distributed file system can still provide data stored in the at least one node to the outside even if all the other nodes fail. In the distributed file system, the number of backup copies of data is usually set to indicate the number of copies of data which has been backed up in the whole distributed file system.

Conventionally, when one of the data nodes fails, the number of backup copies of the data stored in the data node will be reduced, and therefore, the number of backup copies of the data is required to be increased by other data nodes, so as to ensure that the number of backup copies of the data always meets in the distributed file system.

In a conventional distributed file system, when joining the distributed file system, a new data node transmits a list of data stored in the new data node to a metadata node and continuously updates this list in the running process of the distributed file system. The metadata node is a device for managing the whole system in the distributed file system. When the new data node fails, the metadata node recovers all data stored in the data node according to the list provided by the new data node, that is, to back up all data of the new date node to the other data nodes originally in the distributed file system.

During the implementation of the present invention, the inventor finds that, if a data node with a large amount of data stored fails, the metadata node needs to perform a lot of operations to complete the data recovery, and thus the working load of the metadata node is much too heavy.

### SUMMARY OF THE INVENTION

Embodiments of the present invention provide a data recovery method, a data node, and a distributed file system to reduce the load of a metadata node during the data recovery.

A data recovery method includes: by a first data node, obtaining a notification that a second data node fails; and storing specified data to a third data node, recording information of the specified data stored in the third data node in backup information stored in the first data node, and providing a metadata node and other data nodes storing the specified data with the information of the specified data stored in the third data node, where the specified data is the data stored in the first and second data nodes.

A data node includes: a first storing unit, configured to store data; a second storing unit, configured to store backup information of the data stored in the first storing unit; a first exchanging unit, configured to obtain a notification that a second data node fails; and a second exchanging unit, configured to communicate with other data nodes. After the first exchanging unit obtains the notification that the second data node fails, the second exchanging unit stores specified data to a third data node; the second storing unit records information of the specified data stored in the third data node in the stored backup information; the first exchanging unit provides a metadata node with the information of the specified data stored in the third data node; and the second exchanging unit provides other data nodes storing the specified data with the information of the specified data stored in the third data node. The specified data is the data stored in the data node and the second data node.

A data node includes: a third storing unit, configured to store data; a fourth storing unit, configured to store backup information of the data stored in the third storing unit; a third exchanging unit, configured to obtain a notification that a second data node fails; and a fourth exchanging unit, configured to communicate with other data nodes. After the third exchanging unit obtains the notification that the second data node fails, and the fourth exchanging unit obtains the data and backup information of the data provided by the first data node, the third storing unit stores the data; and the fourth storing unit stores the backup information of the data. The data is the data stored in the second data node.

A distributed file system includes: a metadata node and data nodes each having backup information of data stored therein. If a second data node fails, the metadata node sends a notification that the second data node fails to all data nodes except the second data node; a first data node stores specified data to a third data node, records information of the specified data stored in the third data node in the backup information stored in the first data node, and provides the metadata node and other data nodes storing the specified data with the information of the specified data stored in the third data node, where the specified data is the data stored in the first and second data nodes; when obtaining from the first data node the information of the specified data stored in the third data node, the other data nodes storing the specified data record the information of the specified data stored in the third data node in the backup information stored in the other data nodes; and, when obtaining the specified data and the backup information of the specified data provided by the first data node, the third data node stores the specified data and the backup information of the specified data.

In the embodiments of the present invention, each data node in the distributed file system has the backup information of data stored therein, and when a data node fails, the metadata node provides all data nodes with the information that the data node fails and recovers the data stored in the failed data node. In the whole process, the data recovery is mainly performed among the data nodes, and the metadata node does not need to perform a lot of operations. Therefore, the load of the metadata node is reduced.

### BRIEF DESCRIPTION OF THE DRAWINGS

To explain the technical solution of the embodiments of the present invention more clearly, the following briefly describes the drawings required in the description of the embodiments. Obviously, the drawings are exemplary only, and those skilled in the art may obtain other drawings according to the drawings without creative efforts.

FIG. 1 is a flowchart of a data recovery method according to an embodiment of the present invention;

FIG. 2 is a schematic structural diagram of a data node according to an embodiment of the present invention;

FIG. 3 is a flowchart of another data recovery method according to an embodiment of the present invention;

FIG. 4 is a schematic structural diagram of another data node according to an embodiment of the present invention;

FIG. 5 is a flowchart of another data recovery method according to an embodiment of the present invention;

FIG. 6 is a schematic structural diagram of another data node according to an embodiment of the present invention;

FIG. 7 is a schematic structural diagram of a directory of each data node in an application example according to an embodiment of the present invention;

FIG. 8 is a logical structural diagram of files in a distributed file system, before data recovery is started, in an application example according to an embodiment of the present invention;

FIG. 9 is a logical structural diagram of files in a distributed file system, after data recovery is started, in an application example according to an embodiment of the present invention;

FIG. 10 is a flowchart of a data recovery method according to another embodiment of the present invention; and

FIG. 11 is a flowchart of another data recovery method according to another embodiment of the present invention.

### DETAILED DESCRIPTION OF THE EMBODIMENTS

First, it should be noted that the described embodiments are all applied in a distributed file system. The distributed file system includes a metadata node and multiple data nodes.

Each of the data nodes has backup information of the data stored therein. For example, assuming that one data node stores five pieces of data, and that the first piece of data is stored in other two data nodes in addition to the data node, the data node needs to record the information that the first piece of data is stored in the other two data nodes.

During the specific implementation, a directory corresponding to other data nodes may be set in each data node, and, if any data node stores the data same as that stored in another data node, in the data node, the directory corresponding to the other data node has the information of the same data.

It is assumed that the distributed file system includes data node 1, data node 2, and data node 3, where data node 1 stores data A, data B, and data C, data node 2 stores data C, data D, and data E, and data node 3 stores data A, data C, and data E. A directory 2 corresponding to data node 2 may be set in data node 1, and has the information of data C because data nodes 1 and 2 both store data C. In addition, a directory 3 corresponding to data node 3 may be set in data node 1, and has the information of data A and C because data nodes 1 and 3 both store data A and C. Likewise, a directory 1 corresponding to data node 1 may be set in data node 2, and has the information of data C because data nodes 1 and 2 both store data C. In addition, another directory 3 corresponding to data node 3 may be set in data node 2, and has the information of data C and E because data nodes 2 and 3 both store data C and E. Likewise, another directory 1 corresponding to the data node 1 may be set in data node 3, and has the information of data A and C because data nodes 1 and 2 both store data A and C. In addition, another directory 2 corresponding to the data node 2 may be set in the data node 3, and has the information of data C and E because data nodes 2 and 3 both store data C and E.

Optionally, in each data node, a data node list may be set for each piece of stored data. The saved information of data nodes in the list is the information of the data nodes storing the data, that is, in one data node, any saved data corresponds to a data node list which specifies the data nodes storing the data. For example, assuming that data N is stored in data nodes 1, 3, and 6, in data node 1, the data node list corresponding to the data N is as follows:

TABLE 1
Data node 1
Data node 3
Data node 6

During actual application, if a data node has multiple copies of the same data, the access to the data provided by the distributed file system for the outside in a short time is substantially limited when the data node fails. Therefore, the same data preferably has only one backup copy in the same node to avoid the preceding case.

In addition, the data in the embodiments of the present invention may be organized in the form of files. For example, data A, B, C, D, and E may be regarded as files A, B, C, D, and E, respectively. Moreover, the content in each file may be complete, for example, one file as a piece of complete music, or one part of a complete content, for example, one file as a clip of a movie. In the actually application, the fragments of the complete content may be stored in different data nodes.

Furthermore, the failure of a data node mentioned in the following embodiments means all the phenomena that the data node cannot provide the normal service of data access temporarily due to, for example, hardware failure, software failure, overload, heavy access traffic, etc.

The embodiments of the present invention may be described from the perspective of a data node or a distributed file system. To recover data, normally, a data node is required to initiate the data recovery; in addition, a data node is required to modify the backup information only, or a data node is required to store the data to be recovered. Therefore, the embodiments of the present invention may be described from the perspective of a data node initiating the data recovery, or from the perspective of a data node modifying the backup information only, or from the perspective of a data node storing the data to be recovered.

First, a data recovery method is described from the perspective of a data node initiating the data recovery. As mentioned above, the method may be applied in a distributed file system which includes a metadata node and data nodes each having backup information of data stored therein.

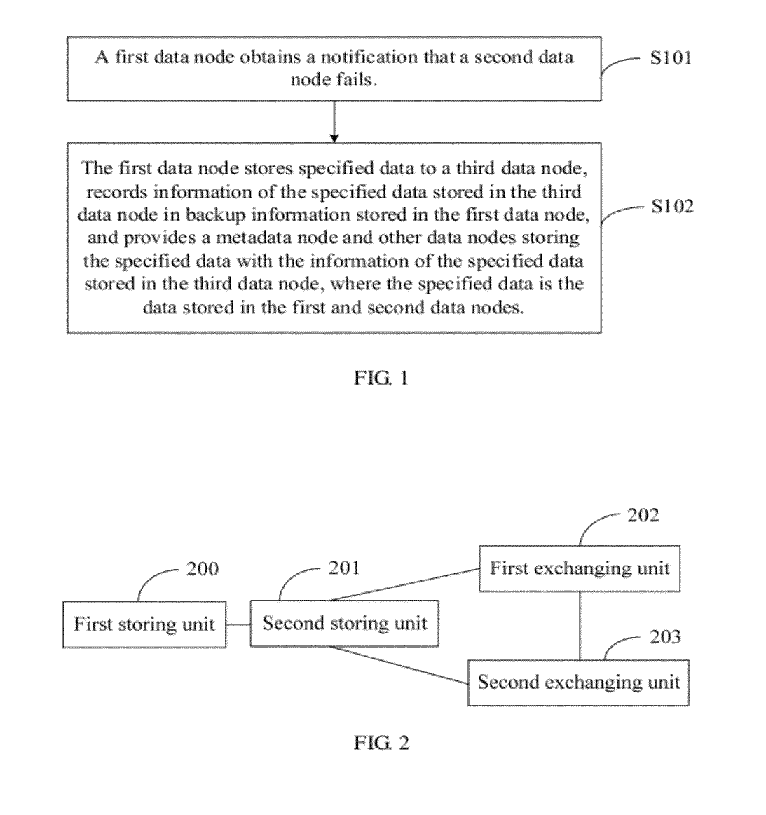

As shown in FIG. 1, the method includes the following steps:

S101: A first data node obtains a notification that a second data node fails.

S102: The first data node stores specified data to a third data node, records information of the specified data stored in the third data node in backup information stored in the first data node, and provides a metadata node and other data nodes storing the specified data with the information of the specified data stored in the third data node, where the specified data is the data stored in the first and second data nodes.

The notification that the second data node fails obtained by the first data node may be sent from the metadata node. In addition to the information that the second data node fails, the notification may include a command to request all data nodes to report the backup information of data of the second data node.

After obtaining the notification that the second data node fails, the first data node may recover the specified data. Obviously, the specified data is the data originally stored in the second data node and the data stored in the first data node.

During actual application, it may be preset that the first data node has the right to recover the specified data, while other data nodes storing the specified data have no right to recover the specified data. For example, it is preset that: when the second data node fails, only the first data node may recover one or more pieces of data stored in the first and second data nodes, while other data nodes storing such data may not recover such data. It should be noted that the specified data may be preset, that is, pre-specified.

Optionally, after obtaining the notification that the second data node fails, and before backing up (also called storing hereinafter) the specified data to the third data node, if having the backup information of data of the second data node, the first data node may report the backup information of data of the second data node to the metadata node. The first data node having the backup information of data of the second data node may be embodied as follows: a directory corresponding to the second data node and set in the first data node has the information of data of the second data node, or a directory corresponding to the second data node and set in the first data node has the information of data of the second data node and directories corresponding to other data nodes and set in the first data node have the information of data of the second data node. In this case, the first data node having the right to recover the specified data may be embodied as follows: the first data node obtains a trigger to recover the specified data, that is, the metadata node specifies the first data node to recover the specified data. The first data node obtaining the trigger to recover the specified data may be embodied as follows: the first data node obtains a command from the metadata node to recover the specified data in the second data node.

When recovering the specified data, the first data node may back up the specified data to the third data node, and specifically, provide the third data node with the specified data, where the third data node is a data node not storing the specified data.

When recovering the specified data, the first data node may further record the information of the specified data backed up to the third data node in the backup information stored in the first data node, and specifically, delete the information of the specified data from the directory corresponding to the second data node and add such information in the directory corresponding to the third data node.

Corresponding to the method shown in FIG. 1, an embodiment of the present invention provides a data node. As mentioned above, the data node may be applied in a distributed file system which includes a metadata node and data nodes each having backup information of data stored therein.

As shown in FIG. 2, the data node includes: a first storing unit 200, configured to store data; a second storing unit 201, configured to store backup information of the data stored in the first storing unit 200; a first exchanging unit 202, configured to obtain a notification that a second data node fails; and a second exchanging unit 203, configured to communicate with other data nodes. After the first exchanging unit 202 obtains the notification that the second data node fails, the second exchanging unit 203 backs up the specified data to a third data node; the second storing unit 201 records information of the specified data stored in the third data node in the stored backup information; the first exchanging unit 202 provides a metadata node with the information of the specified data stored in the third data node; and the second exchanging unit 203 provides other data nodes storing the specified data with the information of the specified data stored in the third data node. The specified data is the data stored in the first storing unit 200 and the second data node.

The notification that the second data node fails obtained by the first exchanging unit 202 may be sent from the metadata node. In addition to the information that the second data node fails, the notification may include a command to request all data nodes to report the backup information of data of the second data node.

After the first exchanging unit 202 obtains the notification that the second data node fails, the data node shown in FIG. 2 may recover the specified data. Obviously, the specified data is the data originally stored in the second data node and the data stored in the first storing unit 200.

During actual application, it may be preset that the data node shown in FIG. 2 has the right to recover the specified data, while other data nodes storing the specified data have no right to recover the specified data. For example, it is preset that: when the second data node fails, only the data node shown in FIG. 2 may recover one or more pieces of data stored in the first storing unit 200 and the second data node, while other data nodes storing such data may not recover such data. It should be noted that the specified data may be preset, that is, pre-specified.

Optionally, after the first exchanging unit 202 obtains the notification that the second data node fails, and before the second exchanging unit 203 backs up the specified data to the third data node, if the second storing unit 201 has the backup information of data of the second data node, the first exchanging unit 202 may report the backup information of data of the second data node stored in the second storing unit 201 to the metadata node. The second storing unit 201 having the backup information of data of the second data node may be embodied as follows: a directory corresponding to the second data node and set in the second storing unit 201 has the information of data of the second data node, or a directory corresponding to the second data node and set in the second storing unit 201 has the information of data of the second data node and directories corresponding to other data nodes and set in the second storing unit 201 have the information of data of the second data node. In this case, the data node having the right to recover the specified data may be embodied as follows: the data node shown in FIG. 2 obtains a trigger to recover the specified data, that is, the metadata node specifies the data node shown in FIG. 2 to recover the specified data. The data node obtaining the trigger to recover the specified data may be embodied as follows: the first exchanging unit 202 obtains a command from the metadata node to recover the specified data in the second data node.

When the data node shown in FIG. 2 recovers the specified data, the second exchanging unit 203 may back up the specified data to the third data node, and specifically, provide the third data node with the specified data, where the third data node is a data node not storing the specified data.

When the first data node recovers the specified data, the second storing unit 201 may record the information of the specified data backed up to the third data node in the backup information stored in the second storing unit 201, and specifically, delete the information of the specified data from the directory corresponding to the second data node and add such information in the directory corresponding to the third data node.

The embodiments corresponding to FIG. 1 and FIG. 2 are described from the perspective of a data node initiating the data recovery, and the following embodiments of the present invention are described from the perspective of a data node only modifying the backup information.

First, a data recovery method is described from the perspective of a data node only modifying the backup information. As mentioned above, the method may be applied in a distributed file system which includes a metadata node and data nodes each having backup information of data stored therein.

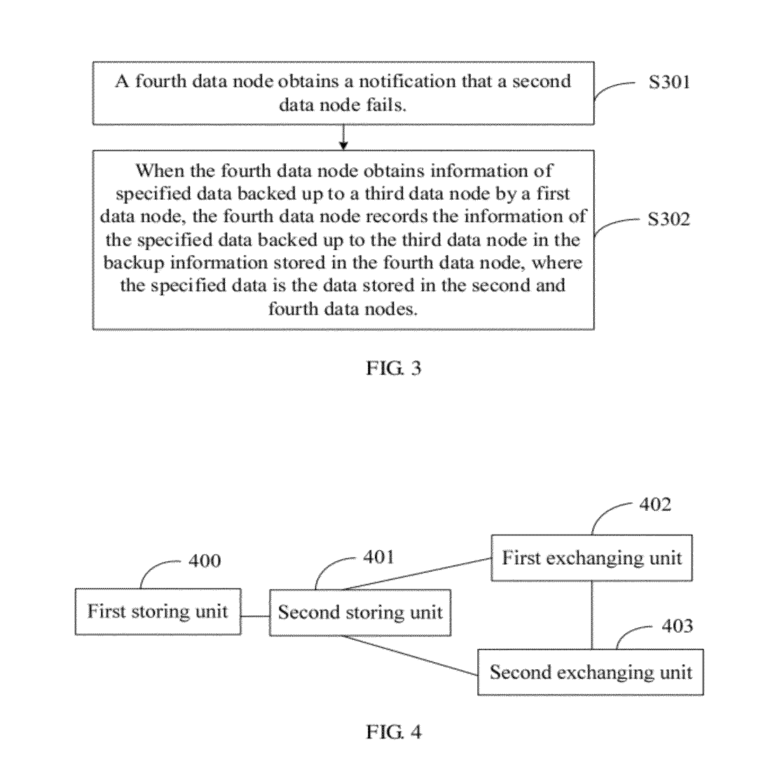

As shown in FIG. 3, the method includes the following steps:

S301: A fourth data node obtains a notification that a second data node fails.

S302: When the fourth data node obtains information of specified data backed up to a third data node by a first data node, the fourth data node records the information of the specified data backed up to the third data node in the backup information stored in the fourth data node, where the specified data is the data stored in the second and fourth data nodes.

The notification that the second data node fails obtained by the fourth data node may be sent from the metadata node. In addition to the information that the second data node fails, the notification may include a command to request all data nodes to report the backup information of data of the second data node.

Optionally, after obtaining the notification that the second data node fails, and before obtaining the information of the specified data backed up to the third data node by the first data node, if having the backup information of data of the second data node, the fourth data node may report the backup information of data of the second data node to the metadata node.

If the first data node backs up the specified data to the third data node, and the fourth data node also stores the specified data, the first data node may provide the fourth data node with the information of the specified data backed up to the third data node, that is, the fourth data node obtains the information of the specified data backed up to the third data node by the first data node, and specifically, the fourth data node obtains from the first data node the information of the specified data backed up to the third data node by the first data node.

After obtaining the information of the specified data backed up to the third data node, the fourth data node may record the information of the specified data backed up to the third data node in the backup information stored in the fourth data node, and specifically, delete the information of the specified data from the directory corresponding to the second data node and add such information in the directory corresponding to the third data node.

Corresponding to the method shown in FIG. 3, an embodiment of the present invention provides a data node. As mentioned above, the data node may be applied in a distributed file system which includes a metadata node and data nodes each having backup information of data stored therein.

As shown in FIG. 4, the data node includes: a first storing unit 400, configured to store data; a second storing unit 401, configured to store backup information of data stored in the first storing unit 400; a first exchanging unit 402, configured to obtain a notification that a second data node fails; and a second exchanging unit 403, configured to communicate with other data nodes. After the first exchanging unit 402 obtains the notification that the second data node fails, and the second exchanging unit 403 obtains the information of the specified data backed up to a third data node by a first data node, the second storing unit 401 records information of the specified data backed up to the third data node in the stored backup information. The specified data is data stored in the first storing unit 400 and the second data node.

The notification that the second data node fails obtained by the first exchanging unit 402 may be sent from the metadata node. In addition to the information that the second data node fails, the notification may include a command to request all data nodes to report the backup information of data of the second data node.

Optionally, after the first exchanging unit 402 obtains the notification that the second data node fails, and before the second exchanging unit 403 obtains the information of the specified data backed up to the third data node by the first data node, if the second storing unit 401 stores the backup information of data of the second data node, the first exchanging unit 402 may report the backup information of data of the second data node stored in the data node shown in FIG. 4 to the metadata node.

If the first data node backs up the specified data to the third data node, and the data node shown in FIG. 4 also stores the specified data, the first data node may provide the data node shown in FIG. 4 with the information of the specified data backed up to the third data node, that is, the second exchanging unit 403 obtains the information of the specified data backed up to the third data node by the first data node, and specifically, the second exchanging unit 403 obtains from the first data node the information of the specified data backed up to the third data node by the first data node.

After the second exchanging unit 403 obtains the information of the specified data backed up to the third data node, the second storing unit 401 may record the information of the specified data backed up to the third data node in the stored backup information, and specifically, delete the information of the specified data from the directory corresponding to the second data node and add such information in the directory corresponding to the third data node.

The embodiments corresponding to FIG. 1 and FIG. 2 are described from the perspective of a data node initiating the data recovery, and the embodiments corresponding to FIG. 3 and FIG. 4 are described from the perspective of a data node only modifying the backup information. The following embodiments of the present invention are described from the perspective of a data node storing data to be recovered.

First, a data recovery method is described from the perspective of a data node storing data to be recovered. As mentioned above, the method may be applied in a distributed file system which includes a metadata node and data nodes each having backup information of data stored therein.

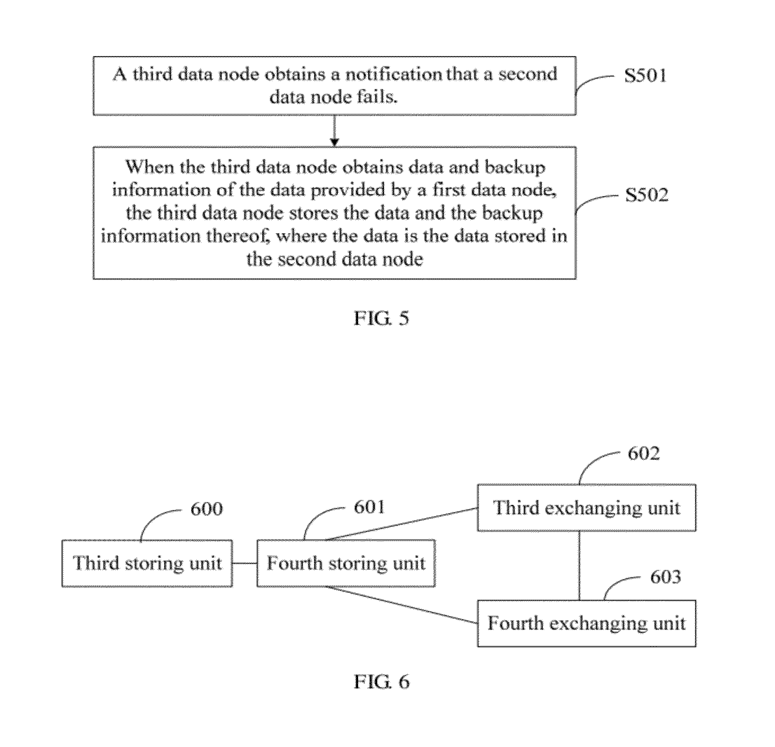

As shown in FIG. 5, the method includes the following steps:

S501: A third data node obtains a notification that a second data node fails.

S502: When the third data node obtains data and backup information of the data provided by a first data node, the third data node stores the data and the backup information thereof, where the data is the data stored in the second data node.

The notification that the second data node fails obtained by the third data node may be sent from the metadata node. In addition to the information that the second data node fails, the notification may include a command to request all data nodes to report the backup information of data of the second data node.

Optionally, after obtaining the notification that the second data node fails, and before obtaining the data and the backup information of the data provided by the first data node, if having the backup information of data of the second data node, the third data node may report the backup information of data of the second data node to the metadata node.

If the first data node backs up the data to the third data node, the first data node needs to provide the third data node with the data, that is, the third data node obtains the data provided by the first data node. In addition, if the data is stored in other data nodes in addition to the first and second data nodes, the first data node further provides the third data node with the information of other data nodes, that is, the third data node further obtains the information of other data nodes. Therefore, in addition to the data, the third data node stores the backup information of the data.

The third data node storing the backup information of the data may be embodied as follows: the third data node adds the information of the data in the directories corresponding to the data nodes storing the data.

Corresponding to the method shown in FIG. 5, an embodiment of the present invention further provides a data node. As mentioned above, the data node may be applied in a distributed file system which includes a metadata node and data nodes each having backup information of data stored therein.

As shown in FIG. 6, the data node, includes: a third storing unit 600, configured to store data; a fourth storing unit 601, configured to store backup information of the data stored in the third storing unit 600; a third exchanging unit 602, configured to obtain a notification that a second data node fails; and a fourth exchanging unit 603, configured to communicate with other data nodes. After the third exchanging unit 602 obtains the notification that the second data node fails, and the fourth exchanging unit 603 obtains the data and the backup information of the data provided by a first data node, the third storing unit 600 stores the data; and the fourth storing unit 601 stores the backup information of the data. The data is the data stored in the second data node.

The notification that the second data node fails obtained by the third exchanging unit 602 may be sent from the metadata node. In addition to the information that the second data node fails, the notification may include a command to request all data nodes to report the backup information of data of the second data node.

Optionally, after the third exchanging unit 602 obtains the notification that the second data node fails, and before the fourth exchanging unit 603 obtains the data and the backup information of the data provided by the first data node, if the fourth storing unit 601 stores the backup information of data of the second data node, the third exchanging unit 602 reports the backup information of data of the second data node stored in the fourth storing unit 601 to the metadata node.

If the first data node backs up the data to the data node shown in FIG. 6, the first data node needs to provide the data node shown in FIG. 6 with the data, that is, the fourth exchanging unit 603 obtains the data provided by the first data node. In addition, if the data is stored in other data nodes in addition to the first and second data nodes, the first data node further provides the data node shown in FIG. 6 with the information of other data nodes, that is, the fourth exchanging unit 603 further obtains the information of other data nodes. Therefore, in addition to the data, the data node shown in FIG. 6 stores the backup information of the data.

The fourth storing unit 601 storing the backup information of the data may be embodied as follows: the fourth storing unit 601 adds the information of the data in the directories corresponding to the data nodes storing the data.

As mentioned above, the embodiments of the present invention may be described from the perspective of a data node or a distributed file system. The following describes a distributed file system provided in an embodiment of the present invention.

A distributed file system includes: a metadata node and data nodes each having backup information of data stored therein. If a second data node fails, the metadata node sends a notification that the second data node fails to all data nodes except the second data node; a first data node backs up specified data to a third data node, records information of the specified data backed up to the third data node in the backup information stored in the first data node, and provides the metadata node and other data nodes storing the specified data with the information of the specified data backed up to the third data node, where the specified data is the data stored in the first and second data nodes; when obtaining from the first data node the information of the specified data backed up to the third data node, the other data nodes storing the specified data record the information of the specified data backed up to the third data node in the backup information stored in the other data nodes; and, when obtaining the specified data and the backup information of the specified data provided by the first data node, the third data node stores the specified data and the backup information of the specified data.

Optionally, after the metadata node sends the notification that the second data node fails to all data nodes except the second data node, if the data nodes except the second data node have the backup information of data of the second data node, the backup information of data of the second data node is reported to the metadata node.

For details about the metadata node, first data node, third data node, other data nodes storing the specified data (that is, the fourth data node in the embodiment corresponding to FIG. 3 and the data node shown in FIG. 4) and the communication between these data nodes, see the descriptions in the embodiments corresponding to FIG. 1 to FIG. 6.

Furthermore, during actual application, the same data is usually stored in multiple data nodes, and when a data node fails, which data node initiates the recovery of the data may be designed by those skilled in the art according to the actual needs. For example, it may be preset that after a data node fails, one of other data nodes storing the data initiates the recovery. For example, when a data node fails, all data nodes storing the data of the failed data node report backup information of the data of the failed data node, and then the metadata node specifies one of the data nodes to initiate the recovery of one or more pieces of data according to a preset rule or the actual need.

To help those skilled in the art understand the embodiments of the present invention more clearly, the following describes the embodiments of the present invention based on an actual application example.

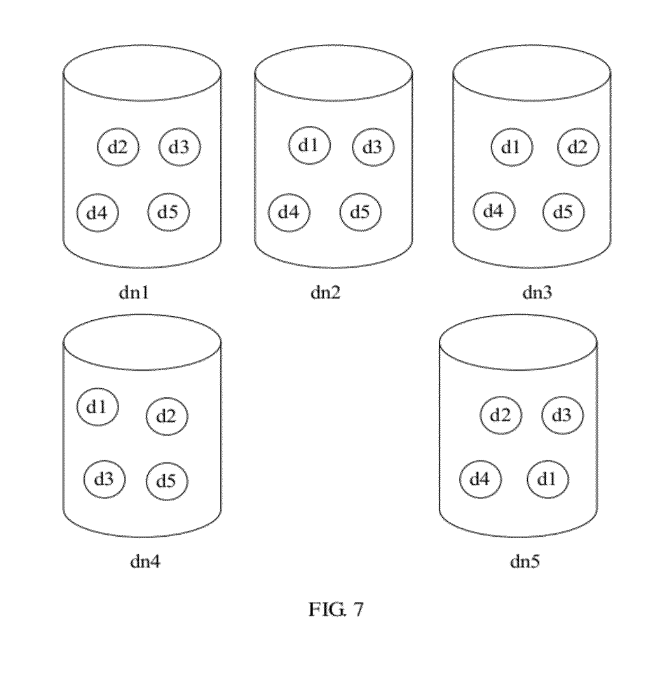

It is assumed that a distributed file system totally includes five data nodes, dn1, dn2, dn3, dn4, and dn5, of which the directory structure is shown in FIG. 7.

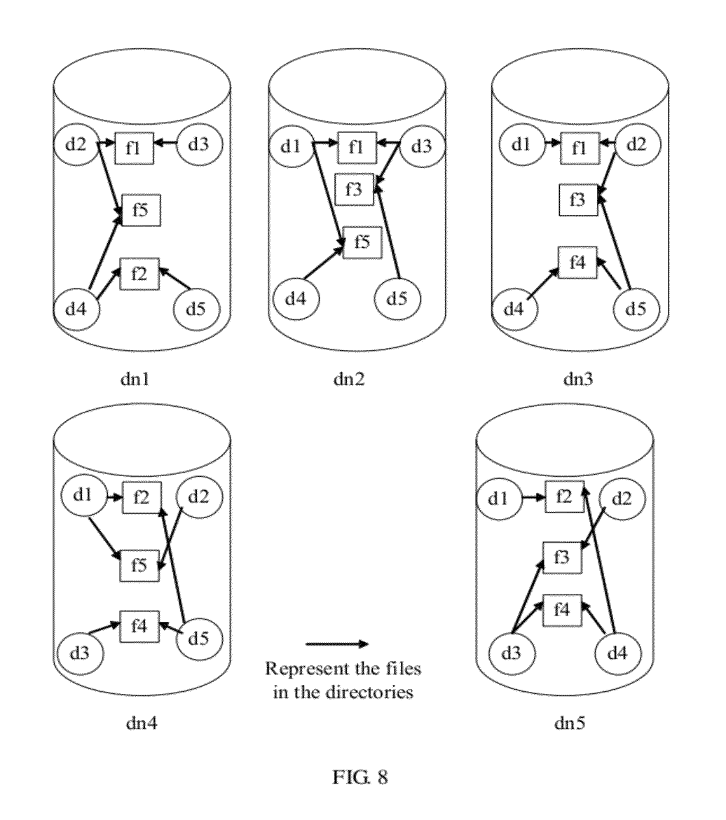

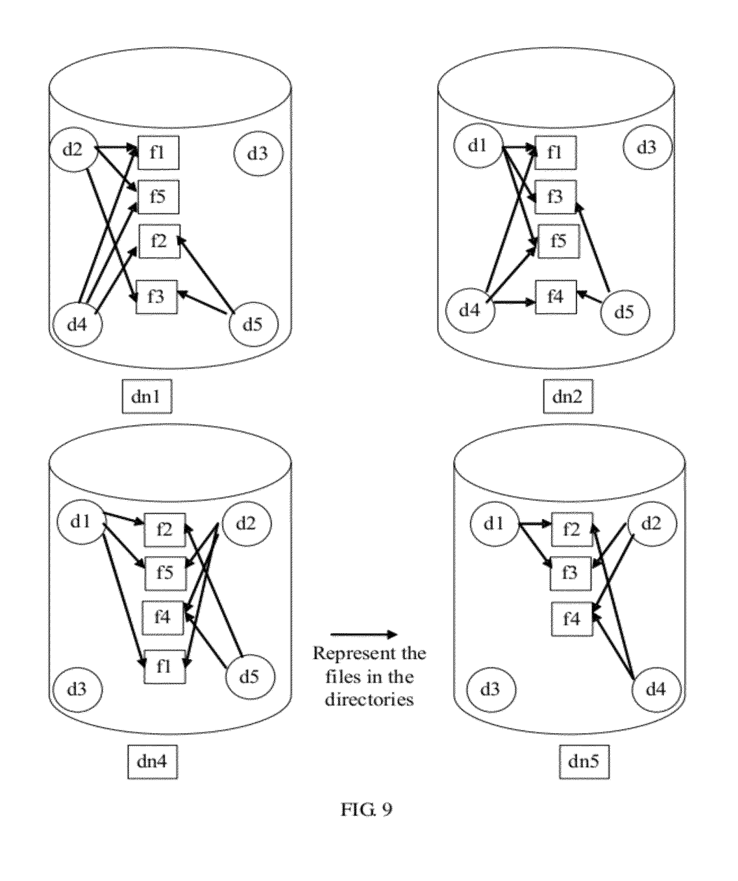

There are five files, f1, f2, f3, f4, and f5, with three backup copies saved in the distributed file system, where: f1 is backed up in dn1, dn2, and dn3; f2 is backed up in dn1, dn4, and dn5; f3 is backed up in dn2, dn3, and dn5; f4 is backed up in dn3, dn4, and dn5; and f5 is backed up in dn1, dn2, and dn4. The logical structure of the files in the distributed system is shown in FIG. 8.

When dn3 fails, the directory d3 of dn1 may determine that f1 needs to be recovered; the directory d3 of dn2 may determine that f1 and f3 need to be recovered; the directory d3 of dn4 may determine that f4 needs to be recovered; and the directory d3 of dn5 may determine that f3 and f4 need to be recovered.

Assuming dn1 recovers f1, dn2 recovers f3, dn4 recovers f4, and dn5 does not need to perform the recovery operation, the detailed recovery process is as follows:

dn 1 copies f1 to dn 4, and transfers the link of f1 from directory d3 to directory d4, that is, the information of f1 is deleted in the directory d3, and added in the directory d4, and then, dn2 is notified to update the information. If a list of data nodes storing f1 is set in dn1, dn3 is changed to dn4 in the list.

dn2 transfers the link of f1 from directory d3 to directory d4, that is, the information of f1 is deleted in the directory d3 and added in the directory d4. If a list of data nodes storing f1 is set in dn2, dn3 is changed to dn4 in the list.

dn 2 copies f3 to dn 1, and transfers the link of f3 from directory d3 to directory d1, that is, the information of f3 is deleted in the directory d3, and added in the directory d1, and then, dn5 is notified to update the information. If a list of data nodes storing f3 is set in dn2, dn3 is changed to dn1 in the list.

dn5 transfers the link of f3 from directory d3 to directory d1, that is, the information of f3 is deleted in the directory d3 and added in the directory d1. If a list of data nodes storing f3 is set in dn5, dn3 is changed to dn1 in the list.

dn 4 copies f4 to dn 2, and transfers the link of f4 from directory d3 to directory d2, that is, the information of f4 is deleted in the directory d3, and added in the directory d2, and then, dn5 is notified to update the information. If a list of data nodes storing f4 is set in dn4, dn3 is changed to dn2 in the list.

dn5 transfers the link of f4 from directory d3 to directory d2, that is, the information of f4 is deleted in the directory d3 and added in the directory d2. If a list of data nodes storing f4 is set in dn5, dn3 is changed to dn2 in the list.

Finally, the logical structure of the files in each node is shown in FIG. 9. The recovery of the files in dn3 is complete.

It should be noted that, in the embodiments above, the directories storing the backup information may further be replaced with structures, such as files.

To sum up, in the embodiments of the present invention, each data node in the distributed file system has the backup information of data stored therein, and when a data node fails, the metadata node provides all data nodes with the information that the data node fails and recovers the data stored in the failed data node. In the whole process, the data recovery is mainly performed among the data nodes, and the metadata node does not need to perform a lot of operations. Therefore, the load of the metadata node is reduced.

Furthermore, in the conventional art, the metadata node needs to query which data is stored in the failed data node, and which data nodes have the backup copies of data stored in the failed data node, thus leading to the low efficiency of data recovery. In the embodiments of the present invention, the data recovery is mainly completed by the cooperation among the data nodes, and the metadata node does not need to query a large amount of information, so the efficiency of data recovery is improved.

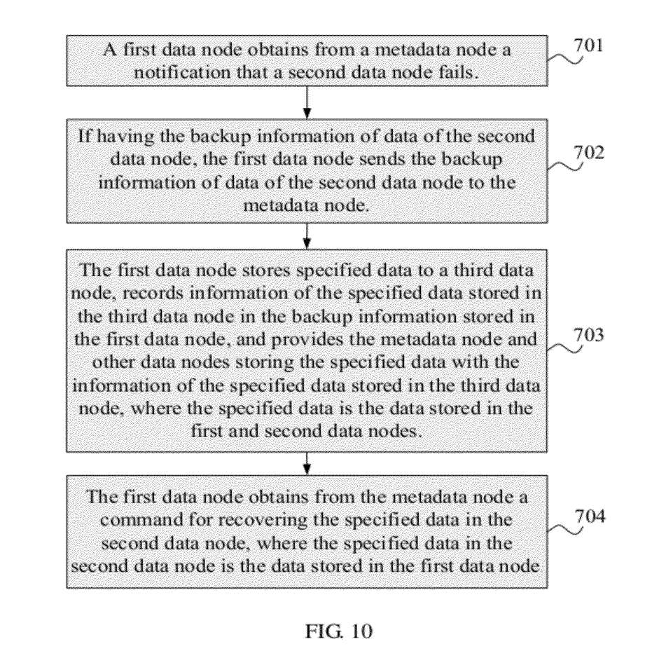

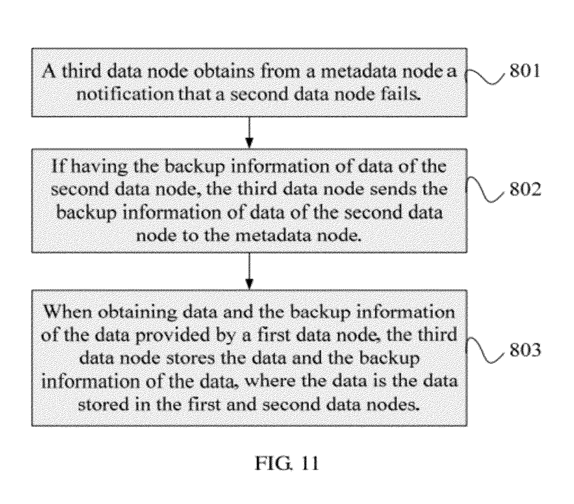

FIG. 10 is a flowchart of a data recovery method in another embodiment of the present invention. The method includes the following steps:

701: A first data node obtains a notification that a second data node fails from a metadata node.

Specifically, in addition to the information that the second data node fails, the notification may include a command to request all data nodes to report the backup information of data of the second data node.

702: If having the backup information of data of the second data node, the first data node sends the backup information of data of the second data node to the metadata node.

Specifically, the first data node having the backup information of data of the second data node may be embodied as follows: a directory corresponding to the second data node and set in the first data node has the information of data of the second data node, or a directory corresponding to the second data node and set in the first data node has the information of data of the second data node and directories corresponding to other data nodes and set in the first data node have the information of data of the second data node.

703: The first data node stores specified data to a third data node, records information of the specified data stored in the third data node in the backup information stored in the first data node, and provides the metadata node and other data nodes storing the specified data with the information of the specified data stored in the third data node, where the specified data is the data stored in the first and second data nodes.

704: The first data node obtains from the metadata node a command for recovering the specified data in the second data node, where the specified data in the second data node is the data stored in the first data node.

Specifically, when recovering the specified data, the first data node may back up the specified data to the third data node, and specifically, provide the third data node with the specified data, where the third data node is a data node not storing the specified data.

When recovering the specified data, the first data node may further record the information of the specified data backed up to the third data node in the backup information stored in the first data node, and specifically, delete the information of the specified data from the directory corresponding to the second data node and add such information in the directory corresponding to the third data node.

In the embodiments of the present invention, each data node in the distributed file system has the backup information of data stored therein, and when a data node fails, the metadata node provides all data nodes with the information that the data node fails and recovers the data stored in the failed data node. In the whole process, the data recovery is mainly performed among the data nodes, and the metadata node does not need to perform a lot of operations. Therefore, the load of the metadata node is reduced.

FIG. 11 is a flowchart of a data recovery method in another embodiment of the present invention. The method includes the following steps:

801: A third data node obtains a notification that a second data node fails from a metadata node.

Specifically, the notification that the second data node fails obtained by the third data node may be sent from the metadata node. In addition to the information that the second data node fails, the notification may include a command to request all data nodes to report the backup information of data of the second data node.

802: If having the backup information of data of the second data node, the third data node sends the backup information of data of the second data node to the metadata node.

803: When obtaining data and the backup information of the data provided by a first data node, the third data node stores the data and the backup information of the data, where the data is the data stored in the first and second data nodes.

Specifically, if the first data node backs up the data to the third data node, the first data node needs to provide the third data node with the data, that is, the third data node obtains the data provided by the first data node. In addition, if the data is stored in other data nodes in addition to the first and second data nodes, the first data node further provides the third data node with the information of other data nodes, that is, the third data node further obtains the information of other data nodes. Therefore, in addition to the data, the third data node stores the backup information of the data.

The third data node storing the backup information of the data may be embodied as follows: the third data node adds the information of the data in the directories or files corresponding to the data nodes storing the data.

In the embodiments of the present invention, each data node in the distributed file system has the backup information of data stored therein, and when a data node fails, the metadata node provides all data nodes with the information that the data node fails and recovers the data stored in the failed data node. In the whole process, the data recovery is mainly performed among the data nodes, and the metadata node does not need to perform a lot of operations. Therefore, the load of the metadata node is reduced.

It should be noted that, the units in the data nodes in the embodiments of the present invention are virtual units, that is, implemented by statements of computer languages or combinations thereof. During actual application, the functions implemented by the combinations of different statements may be different, and the division of the virtual units may also be different. That is, the embodiments of the present invention only provide a division way of the virtual units, but During actual application, those skilled in the art may use different division ways of the virtual units according to the actual needs, only if the functions of the data nodes mentioned herein can be implemented.

Those skilled in the art may understand that all or some processes in the method embodiments above may be implemented by hardware instructed by a computer program. The program may be stored in a computer readable storage medium. When being executed, the program may include the processes of the method embodiments above. The storage medium may be a magnetic disk, a read only memory (ROM), a random access memory (RMA), or a compact disk-read only memory (CD-ROM).

Detailed above are exemplary embodiments of the present invention. It should be noted that various improvements and modifications made by those skilled in the art within the principle of the present invention shall fall within the scope of the present invention.

What is claimed is:

1. A data recovery method, comprising:
obtaining, by a first data node, a notification that a second data node fails;
storing specified data to a third data node, wherein the specified data is originally stored in the first and second data nodes;
recording information of the specified data stored in the third data node into backup information stored in the first data node;
providing a metadata node and other data nodes which are different from the first and second data nodes; and
storing the specified data with the information of the specified data stored in the third data node.

2. The method according to claim 1, wherein a directory or a file corresponding to the other data nodes is set in each of the other data node, and, if any of the data nodes stores data as same as that stored in another data node, in that data node, the directory or file corresponding to the other data node has the information of the same data.

3. The method according to claim 1, wherein the step of obtaining the notification that the second data node fails further comprises: obtaining, by the first data node, the notification that the second data node fails from the metadata node.

4. The method according to claim 1, after obtaining the notification that the second data node fails, and before storing the specified data to the third data node, further comprising: if the first data node has backup information of data of the second data node, sending, by the first data node, the backup information of data of the second data node to the metadata node.

5. The method according to claim 4, wherein the first data node having the backup information of data of the second data node further comprises: a directory or a file corresponding to the second data node and set in the first data node having the information of data of the second data node, or a directory or a file corresponding to the second data node and set in the first data node having the information of data of the second data node and directories or files corresponding to other data nodes and set in the first data node having the information of data of the second data node.

6. The method according to claim 4, further comprising: obtaining, by the first data node, a command from the metadata node to recover the specified data in the second data node, wherein the specified data in the second data node is the data stored in the first data node.

7. The method according to claim 1, wherein the step of recording the information of the specified data stored in the third data node in the backup information stored in the first data node further comprises: by the first data node, deleting the information of the specified data from a directory or a file corresponding to the second data node and adding the information of the specified data in a directory or a file corresponding to the third data node.

8. A data node, comprising:
a first storing unit, configured to store data;
a second storing unit, configured to store backup information of the data stored in the first storing unit;
a first exchanging unit, configured to obtain a notification that a second data node fails; and
a second exchanging unit, configured to communicate with other data node;
wherein, after the first exchanging unit obtains the notification that the second data node fails, the second exchanging unit stores specified data to a third data node; the second storing unit records information of the specified data stored in the third data node in the stored backup information; the first exchanging unit provides a metadata node with the information of the specified data stored in the third data node; and the second exchanging unit provides other data nodes storing the specified data with the information of the specified data stored in the third data node, wherein the specified data is stored in the data node and the second data node.

9. The data node according to claim 8, wherein the recording of the information of the specified data stored in the third data node in the stored backup information further comprises: by the second storing unit, deleting the information of the specified data from a directory or a file corresponding to the second data node and adding the information of the specified data in a directory or a file corresponding to the third data node.

10. A data node, comprising:
a third storing unit, configured to store data;
a fourth storing unit, configured to store backup information of the data stored in the third storing unit;
a third exchanging unit, configured to obtain a notification that a second data node fails; and
a fourth exchanging unit, configured to communicate with other data nodes;
wherein, after the third exchanging unit obtains the notification that the second data node fails, and the fourth exchanging unit obtains data and backup information of the data provided by a first data node, the third storing unit stores the data; and the fourth storing unit stores the backup information of the data, wherein the data is stored in the second data node.

11. The data node according to claim 10, wherein, after the third exchanging unit obtains the notification that the second data node fails, and before the fourth exchanging unit obtains the data and the backup information of the data provided by the first data node, if the fourth storing unit stores backup information of data of the second data node, the third exchanging unit sends the backup information of data of the second data node to a metadata node.

12. The data node according to claim 10, wherein the backup information of the data comprises information of data nodes storing the data, and the storing of the backup information of the data by the fourth data node comprises: adding, by the fourth data node, the information of the data in directories or files corresponding the data nodes storing the data.

13. A distributed file system, comprising: a metadata node and data nodes each having backup information of data stored therein,
wherein, if a second data node fails, the metadata node sends a notification that the second data node fails to all data nodes except the second data node;
a first data node, configured to store specified data to a third data node, record information of the specified data stored in the third data node in the backup information stored in the first data node, and provide the metadata node and the other data nodes which is different from the first and second data nodes, storing the specified data with the information of the specified data stored in the third data node, wherein the specified data is stored in the first and second data nodes;
when obtaining from the first data node the information of the specified data stored in the third data node, the other data nodes storing the specified data record the information of the specified data stored in the third data node in the backup information stored in the other data nodes; and
when obtaining the specified data and the backup information of the specified data from the first data node, the third data node stores the specified data and the backup information of the specified data.

14. The system according to claim 13, wherein after the metadata node sends the notification that the second data node fails to all data nodes except the second data node, if the data nodes except the second data node have backup information of data of the second data node, the backup information of data of the second data node is reported to the metadata node.
